(19) United States
(12) Patent Application Publication
(10) Pub. No.: US 2012/0054089 A1
(43) Pub. Date: Mar. 1, 2012

(54) Method and Apparatus for Providing Ongoing Cash Access

(76) Inventors: David Allen, Agorra Hills, CA (US); Josh Allen, Calabasas, CA (US); Dino Sgueglia, Glen Cove, NY (US)

(21) Appl. No.: 13/220,957

(22) Filed: Aug. 30, 2011

Related U.S. Application Data
(60) Provisional application No. 61/378,655, filed on Aug. 31, 2010.

(51) Int. Cl. G06Q 40/02

(52) U.S. Cl. 705/38; 705/39

(57) ABSTRACT

A method and system for providing ongoing access to cash is disclosed. A funding request is received from a merchant. A maximum approved amount is determined based on analyzing past sales transaction volume data of the merchant. A funded amount is deposited to the merchant account associated with the merchant in response to a request for funds from the merchant.

This application claims the benefit of U.S. Provisional Application No. 61/378,655, filed Aug. 31, 2010, the disclosure of which is herein incorporated by reference.

### FIELD OF THE INVENTION

The present disclosure is generally directed to a method and apparatus for providing ongoing access to cash based on credit card sale amounts.

### BACKGROUND OF THE INVENTION

Business owners encounter many day to day challenges that place them in situations where quick and easy cash access would be beneficial. Traditional sources of funding for merchants or business owners, such as bank loans and traditional lines of credit, require large amounts of paperwork, including financial information and tax returns, and lengthy processing times. In addition, personal guarantees, personal collateral, and a high credit rating are usually required, further slowing and complicating the process. The aforementioned traditional sources of funding may give a business owner access to cash at the instant when cash is necessary.

### BRIEF SUMMARY OF THE INVENTION

In an embodiment, the present invention provides a method and system for providing ongoing access to cash. A funding request is received from a merchant. A maximum approved amount is determined based on analyzing past sales transaction volume data of the merchant. A funded amount is deposited to the merchant account associated with the merchant in response to a request for funds from the merchant.

In another embodiment, receiving the funding request from the merchant comprises receiving a funding request including application information and a requested amount of funding. Determining the maximum approved amount comprises comparing the past sales transaction volume data of the merchant with at least one predetermined threshold. The past sales transaction volume comprises at least one of credit card sales volume data or debit card sales volume data over a predetermined time period.

In an embodiment, a second funding request is received from the merchant. The funding amount is increased by an amount up to the maximum approved amount.

In yet another embodiment, the present invention provides a system and method for payback of a funded amount by a merchant. A payback amount is received from a card processor, the payback amount representing a percentage of an amount of a sales transaction, the sales transaction representing a payment from a consumer to a merchant. The payback amount is adjusted for a future sales transaction in response to receiving the percentage of the amount of the sales transaction.

In an embodiment, the payback amount is a predetermined percentage based upon the different between a maximum approved amount and a funded amount associated with the merchant. Adjusting the payback amount comprises decreasing the predetermined percentage based on the difference between the maximum approved amount and the funded amount or increasing the predetermined percentage based on the difference between the maximum approved amount and the funded amount. Before receiving the payback amount, a funded amount requested by the merchant is deposited to an account associated with the merchant, the funded amount determined based on analyzing past sales transaction volume data of the merchant.

### BRIEF DESCRIPTION OF THE DRAWINGS

FIG. 1 illustrates the parties necessary to implement the method and system for providing ongoing access to cash, in accordance with an embodiment of the present invention;

FIG. 2 illustrates a flow diagram of how a funded amount is approved for provision to a merchant, in accordance with an embodiment of the present invention;

FIG. 3 illustrates a flow diagram of how funding organization receives payback of the funded amount from the merchant, in accordance with an embodiment of the present invention; and

FIG. 4 illustrates a computer adapted to implement the methods described herein.

### DETAILED DESCRIPTION

The following description, including exemplary embodiments and corresponding Figures, are aimed at providing a method and apparatus for providing ongoing cash access. The present invention facilitates providing ongoing access to cash to a user directly to their bank account or through the issuance of a debit card, without any interest or fixed payback schedule associated with the cash.

Specifically, the system facilitates: 1) funding a debit card or bank account with a funded amount for a merchant, 2) usage of the funded amount by the merchant; and 3) payback of the funded amount by the merchant. Funding requires submission of a funding request by a merchant to a funding organization. The funding request includes an application and a requested amount of cash. The funding organization determines a funded amount based upon an estimate of the future credit card receivables of the merchant. The funded amount is furnished to the merchant as a purchase of the future credit card receivables of the merchant by the funding organization.

The funded amount may increase on an ongoing basis up to a maximum approved amount in response to further funding requests from the merchant to the funding organization. The funded amount may be provided to a debit card or bank account associated with the merchant. The funding organization determines the maximum approved amount based upon the merchant's credit card sales processing volume (or estimated future credit card receivables). A funded amount is provided to the merchant based on a comparison the merchant's credit card sales processing volume with a predetermined threshold.

Thus, any merchant funded by the funding organization makes payments to pay back the funded amount through their future credit card and debit card sales transactions in order to reduce an outstanding balance associated with the merchant. As the outstanding balance decreases, a holdback percentage of the sales transactions may decrease. This signifies that as a merchant pays back the funded amount and reduces their outstanding balance, the holdback percentage of the sales transactions decreases.

As long as the maximum approved amount is not reached, the merchant may submit funding requests for more funds. Funding requests may be submitted online or by paper application, and funds may be provided within a set time period, for example 48 hours. A merchant may use the funded amount at any location accepting the debit card that the funded amount is deposited on, or a bank account holding the funded amount. The aforementioned location may include a physical location such as an ATM machine, retail store, or bank, or a website on the Internet.

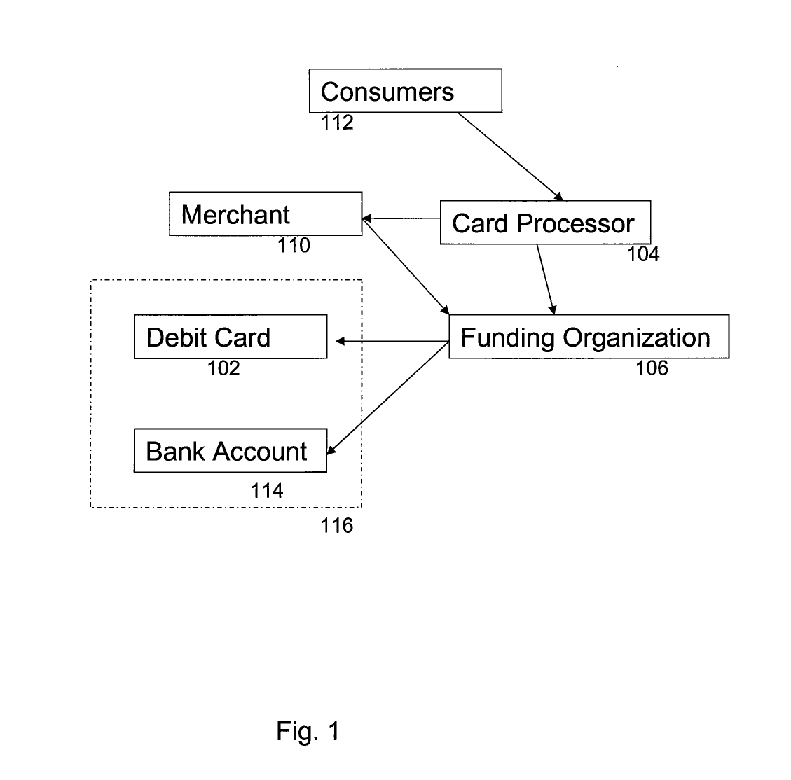

FIG. 1 illustrates funding organization 106 which provides funds to a debit card 102, or alternatively a bank account 114, in accordance with an embodiment of the present invention. In order to fund a merchant account 116, such as either debit card 102 or bank account 114, merchant 110 may send or transmit a funding request to funding organization 106. If the funding request is approved by funding organization 106, funding organization 106 provides a funded amount, an amount of funds less than or equal to the funding request, to merchant 110 via deposit to merchant account 116. Once the funded amount is available on merchant account 116, merchant 110 may make purchases or withdraw cash from merchant account 116 (bank account 114 or debit card 102).

Merchant 110 may make an unlimited number of funding requests in order to further increase the funded amount up to a maximum approved amount. Funds that are approved and deposited on debit card 102 or bank account 114 are not bound by any type of spending restrictions. An approved funded amount is made available for use through debit card 102 or bank account 114 within a predetermined period of time, for example, 48 hours.

Card processor 104 processes sales transactions made by consumers 112 to merchant 110. Sales transactions may comprise debit or credit card sales transactions paid to merchant 110 in exchange for goods or services. These sales transactions are processed by card processor 104, which communicates with funding organization 106. As each sales transaction is processed, a percentage of each sales transaction is applied as payback of the funded amount granted to merchant 110 to reduce an outstanding balance of merchant 110. The percentage of each sales transaction is transmitted from card processor 104 to funding organization 106 and is used to reduce the outstanding balance owed to funding organization 106 by merchant 110 from having the funded amount deposited to one of the merchant accounts 116.

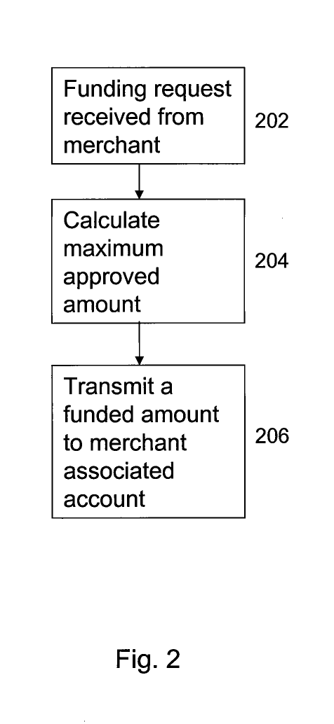

FIG. 2 illustrates a flow diagram of how funds are provided to a merchant from a funding organization in accordance with an embodiment of the present invention. At step 202, a funding request is made by merchant 110 to funding organization 106. Thus, a funding request is received by funding organization 106 from merchant 110. Specifically, an application or an information form including a requested amount of funds may be submitted by merchant 110 as the funding request to funding organization 106. After receiving the funding request, funding organization must make a determination regarding whether or not to approve the funding request.

At step 204, a maximum approved amount for merchant 110 is calculated. Calculation of the maximum approved amount is based upon an algorithm comparing the past sales transaction volume of merchant 110 from debit and/or credit card sales with several predetermined thresholds over a period of time. For example, a three month sales volume average for merchant 110 may be compared with the predetermined thresholds to determine the maximum approved amount to be released to merchant 110. The predetermined threshold may be set at some percentage of merchant 110's average sales volume over a set time period. For example, merchant 110's maximum approved amount may be determined to be 100% of their average monthly sales volume over a three month time period. Based on the algorithm comparing past sales transaction volume to the predetermined thresholds, merchant 110 may receive a maximum approved amount less than or equal to the amount requested with the funding request.

At step 206, funding organization 106 transmits a funded amount less than or equal to the maximum approved amount to either debit card 102 or bank account 114 in response to a request from merchant 110. Once merchant 110 activates debit card 102 or bank account 114, merchant 110 will have instant access to the funded amount. The funded amount becomes an outstanding amount to funding organization 106. Payback of the funded amount is discussed in greater detail below.

Any subsequent funding requests from merchant 110 to funding organization 106 to increase the funded amount may be approved or declined based on the remaining availability (maximum approved amount minus funded amount. By completing this process, merchant 110 has ongoing access to cash.

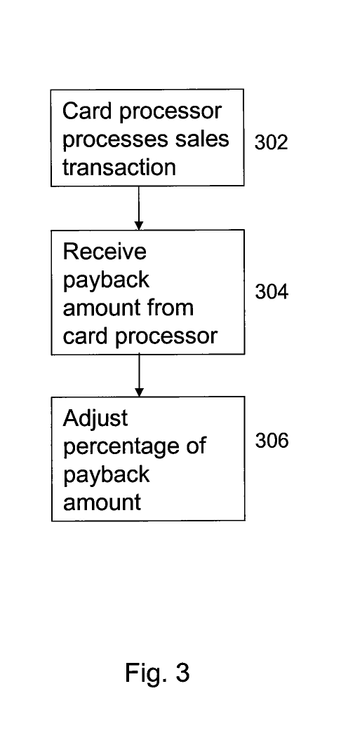

FIG. 3 illustrates a flow diagram of how funding organization 106 receives payback of the funded amount from merchant 110 in accordance with an embodiment of the present invention. At step 302, a credit or debit card sale transaction is processed by card processor 104. The credit or debit card sale transaction represents a payment from a consumer to a merchant for goods or services. This transaction is processed by card processor 104, which is associated with and in communication with funding organization 106.

At step 304, a percentage of the credit or debit card sale transaction is deducted by card processor 104 and transmitted to funding organization 106. The deducted percentage is received by funding organization 106 as a payback amount. The payback amount itself is predetermined percentage taken from each sales transaction of merchant 110 and transmitted to funding organization 106 via card processor 104 to be applied as payback of any outstanding balance of merchant 110 based on a funded amount furnished to merchant 110 by funding organization 106.

At step 306, in response to receiving the payback amount from card processor 104, funding organization 106 may adjust the predetermined percentage or payback amount for any future sales transaction. Thus, as payback amounts are received, funding organization 106 may reduce the predetermined percentage. Payback amounts are determined based on a schedule of predetermined percentages (or holdback percentages) tied to the remaining availability of funds associated with merchant 110. The remaining availability is calculated as the difference between a maximum approved amount and the funded amount in any merchant account 116.

The holdback percentages, discussed above, vary based upon the remaining availability. In general, the higher the remaining availability, the less funds have been requested by merchant 110 for deposit to merchant account 116. Thus, the lower the holdback percentage, and vice versa. For example, if the remaining availability is 65% or greater, a daily holdback percentage may be 10%; if the remaining availability is between 35% and 65%, the daily holdback percentage may be 20%; if the remaining availability is less than 35%, the daily holdback percentage may be 25%. The daily holdback percentage represents the predetermined percentage applied to sales transactions over the course of a given day. As paybacks are made, the paybacks may also be reported to credit bureaus by funding organization 106 to allow a merchant to build business credit.

In yet another embodiment of the present invention, merchants may view a customized web site associated their associated debit card 102 or bank account 114 to view all transactions made, pay bills online, view their total maximum approved amount of funding, amount of paybacks made, and amount of currently available funds. Fund requests may also be made directly through the web site. The aforementioned items viewable on the customized web site may also be viewable through a mobile phone or e-mail account.

In another embodiment of the present invention, a proprietary backend web site is made available for reporting and used as a risk management system for debit card 102 or bank account 114 associated with merchant 110. The web site includes four sections: Administrative, AFO (Alternative Funding Organization), Agent, and Merchant. The Administrative section includes underwriting and risk management and is responsible for managing the entire website including features such as: addition and deletion of AFOs, Agents, and Merchants; Agent Commission management; Merchant activity monitoring and reporting; detailed reports; and accounting. The AFO section provides participating AFOs with the ability to monitor risk by viewing detailed reports for funded merchants, merchant balances, payments, and funds withheld. The Agent section provides a summary of detailed information about all merchant accounts, commission reporting, and sub agent commission reporting. The merchant section allows a merchant to view details of their account, as described above regarding a customized site for merchants.

Thus, debit card 102 and/or bank card 104 provides ongoing access to cash with minimal paperwork requirements, quick underwriting, no personal collateral or traditional personal guarantee requirement, no upfront fees or closing costs, no fixed payment schedule, no reporting to credit agencies, positive feedback reports to build business credit, convenient fund availability, and online account reporting.

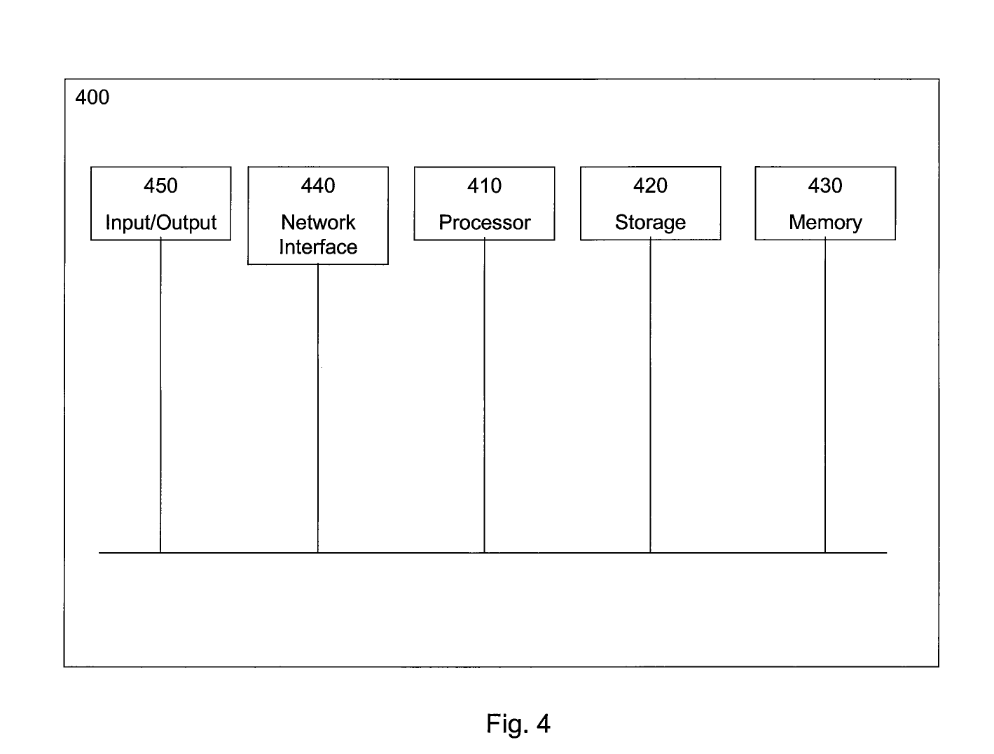

The above-described methods for providing a funded amount to merchant 110 from funding organization 106 and payback of the funded amount from merchant 110 to funding organization 106 can be implemented on a computer using well-known computer processors, memory units, storage devices, computer software, and other components. A high-level block diagram of such a computer is illustrated in FIG. 4. Computer 400 contains a processor 410 which controls the overall operation of the computer 400 by executing computer program instructions which define such operations. The computer program instructions may be stored in a storage device 420, or other computer readable medium (e.g., magnetic disk, CD ROM, etc.), and loaded into memory 430 when execution of the computer program instructions is desired. Thus, the method steps of FIGS. 2 and 3 can be defined by the computer program instructions stored in the memory 430 and/or storage 420 and controlled by the processor 410 executing the computer program instructions. For example, the computer program instructions can be implemented as computer executable code programmed by one skilled in the art to perform an algorithm defined by the method steps of FIGS. 2 and 3. Accordingly, by executing the computer program instructions, the processor 410 executes an algorithm defined by the method steps of FIGS. 2 and 3. The computer 400 also includes one or more network interfaces 440 for communicating with other devices via a network. The computer 400 also includes input/output devices 450 that enable user interaction with the computer 400 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes.

The foregoing Detailed Description and Drawings are to be understood as being in every respect illustrative and exemplary, but not restrictive, and the scope of the embodiments disclosed herein is not to be determined from the Detailed Description alone, but rather from the Drawings as well, as interpreted according to the full breadth permitted by the patent laws. It is to be understood that the embodiments shown and described herein by the Detailed Description and Drawings are only illustrative and exemplary of the principles of the present embodiments and that various modifications may be implemented by those skilled in the art without departing from the scope and spirit of the embodiments described herein. Those skilled in the art could implement various other feature combinations without departing from the scope and spirit of the embodiments of the present disclosure.

We claim:

1. A method, comprising:
receiving a funding request from a merchant;
determining a maximum approved amount based on analyzing past sales transaction volume data of the merchant; and
depositing a funded amount to a merchant account associated with the merchant in response to a request for funds from the merchant.

2. The method of claim 1, wherein receiving a funding request from a merchant comprises:
receiving a funding request including application information and a requested amount of funding.

3. The method of claim 1, wherein determining the maximum approved amount comprises:
comparing the past sales transaction volume data of the merchant with at least one predetermined threshold.

4. The method of claim 1, wherein the past sales transaction volume comprises at least one of credit card sales volume data or debit card sales volume data over a predetermined time period.

5. The method of claim 1, further comprising:
receiving a second funding request from the merchant; and
increasing the funded amount deposited to the merchant account by an amount up to the maximum approved amount.

6. A system, comprising:
means for receiving a funding request from a merchant;
means for determining a maximum approved amount based on analyzing past sales transaction volume data of the merchant; and
means for depositing a funded amount to a merchant account associated with the merchant in response to a request for funds from the merchant.

7. The system of claim 6, wherein means for receiving a funding request from a merchant comprises:
means for receiving a funding request including application information and a requested amount of funding.

8. The system of claim 6, wherein means for determining the maximum approved amount comprises:
means for comparing the past sales transaction volume data of the merchant with at least one predetermined threshold.

9. The system of claim 6, wherein the past sales transaction volume comprises at least one of credit card sales volume data or debit card sales volume data over a predetermined time period prior to receiving the funding request.

10. The system of claim 6, further comprising:
means for receiving a second funding request from the merchant; and
means for increasing the funded amount deposited to the merchant account by an amount up to the maximum approved amount.

11. A method, comprising:
receiving a payback amount from a card processor, the payback amount representing a percentage of an amount of a sales transaction, the sales transaction representing a payment from a consumer to a merchant; and
adjusting the payback amount for a future sales transaction in response to receiving the percentage of the amount of the sales transaction.

12. The method of claim 11, wherein the payback amount is a predetermined percentage based upon the difference between a maximum approved amount and a funded amount associated with the merchant.

13. The method of claim 12, wherein adjusting the payback amount comprises:
decreasing the predetermined percentage based on the difference between the maximum approved amount and the funded amount.

14. The method of claim 12, wherein adjusting the payback amount comprises:
increasing the predetermined percentage based on the difference between the maximum approved amount and the funded amount.

15. The method of claim 11, further comprising:
before receiving the payback amount, depositing a funded amount requested by the merchant to an account associated with the merchant, the funded amount determined based on analyzing past sales transaction volume data of the merchant.

16. The system, comprising:
means for receiving a payback amount from a card processor, the payback amount representing a percentage of an amount of a sales transaction, the sales transaction representing a payment from a consumer to a merchant; and
means for adjusting the payback amount for a future sales transaction in response to receiving the percentage of the amount of the sales transaction.

17. The system of claim 16, wherein the payback amount is a predetermined percentage based upon the difference between a maximum approved amount and a funded amount associated with the merchant.

18. The system of claim 17, wherein means for adjusting the payback amount comprises:
means for decreasing the predetermined percentage based on the difference between the maximum approved amount and the funded amount.

19. The system of claim 17, wherein adjusting the payback amount comprises:
means for increasing the predetermined percentage based on the difference between the maximum approved amount and the funded amount.

20. The system of claim 16, further comprising:
before receiving the payback amount, depositing a funded amount requested by the merchant to an account associated with the merchant, the funded amount determined based on analyzing past sales transaction volume data of the merchant.
